(19) United States
(12) Patent Application Publication
(10) Pub. No.: US 2008/0075938 A1
(43) Pub. Date: Mar. 27, 2008

(54) Sheet Made of High Molecular Material and Method for Making Same

(75) Inventors: Ching-Tang Wang, Taipei (TW); Wu-Tsang Tsai, Kaohsiung (TW); Lung-Chuan Wang, Kaohsiung Hsien (TW); Chung-Chih Feng, Kaohsiung (TW); Chun-Wei Wu, Kaohsiung Hsien (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: San Fang Chemical Industry Co., Ltd., Kaohsiung Hsien (TW)

(21) Appl. No.: 11/923,819

(22) Filed: Oct. 25, 2007

Related U.S. Application Data
(62) Division of application No. 11/026,869, filed on Dec. 30, 2004.

(30) Foreign Application Priority Data
Dec. 31, 2003 (TW) 092137684

(51) Int. Cl. B32B 7/02; B32B 27/40; C08G 69/00; C08G 73/00

(52) U.S. Cl. 428/213; 428/220; 524/612; 528/422

(57) ABSTRACT

A macromolecular laminate includes a main layer made of a first type of polyurethane resin compound that is liquid at room temperature. The first type of polyurethane resin compound is made through mixing polyurethane resin with solid content higher than 50% by weight with additives. An auxiliary layer may be formed on the main layer and made of a second type of polyurethane resin compound different from the first type of polyurethane resin compound.

### CROSS REFERENCE TO RELATED APPLICATION

This is a divisional application of U.S. patent application Ser. No. 11/026,869 filed Dec. 30, 2004.

### BACKGROUND OF INVENTION

1. Field of Invention

The present invention relates to a macromolecular laminate.

2. Related Prior Art

In a conventional method for making a macromolecular laminate, granular, thin or powdery solid macromolecular compound (such as thermal plastic polyurethane (“TPU”), polypropylene, polyethylene and polyvinyl chloride) is mixed with additives, heated and molten. The mixture is injected, co-extruded or blow-molded to form a macromolecular laminate.

However, in the conventional method, because the solid macromolecular compound is used to make the macromolecular laminate, operative variables must be adjusted in order to solve problems related to melting, rheology and temperature. In a conventional method and equipment, there is a rather high minimum requirement on material. Furthermore, the complicated equipment must be cleaned up in order to make a different laminate. Therefore, it is material-intensive, time-consuming and expensive. In the conventional method for making the laminate, the hardness of the macromolecular resin such as TPU is about 85 to 98 (scale: Shore Hardness, A; test method: ASTM D-2240), and the 100% modulus is about 60 to 130 kg/cm² (test method: ASTM D-412). The laminate is hard, not soft. According to the conventional method and material, the laminate is made with only a few patterns and colors. In the conventional method for using the solid macromolecular compound to make the macromolecular laminate, lubricant or plasticizer is used generally. The lubricant or plasticizer is however released from the surface of the laminate so that the surface of the laminate loses its brightness.

### SUMMARY OF INVENTION

The primary objective of the present invention is to provide a method for making a macromolecular laminate that can obviate or at least alleviate the problems encountered in prior art through making a laminate that can exhibit a lot of patterns and colors and flexibility.

To achieve the above-mentioned objective and other objectives, the present invention provides a method for making a macromolecular laminate. Firstly, a first type of polyurethane resin compound is coated on releasing paper to make a main layer. The first type of polyurethane resin compound is made from polyurethane resin with solid content higher than 50% by weight and is liquid at room temperature. Then, the releasing paper is removed from the main layer, thus leaving a macromolecular laminate.

To make the macromolecular laminate with colors, before the first polyurethane resin compound is coated, a second type of polyurethane resin compound is coated on the releasing paper to form an auxiliary layer. Then, the first type of polyurethane resin compound is coated on the auxiliary layer. The second type of polyurethane resin compound is made of polyurethane resin with solid content lower than 50% by weight. Thus, the auxiliary layer is thinner than the main layer. The auxiliary layer has a different color than the main layer so that the laminate exhibits a bright color. In addition, the releasing paper may include a pattern in order to leave a pattern on the laminate.

The present invention is characterized in using high solid-content polyurethane resin compound that is liquid at room temperature (the first type of polyurethane resin compound) to form the thick macromolecular laminate. Because no solid macromolecular compound is used, there is no need to control complicated variables for solving problems related to the melting, rheology and temperature of such solid macromolecular compound. In addition, a blender and a coating device can be used instead of a conventional bulky and complicated machine. Thus, the laminate can be made at a small or large number based on the need. Furthermore, only the blender and the coating device have to be cleaned between two different batches of laminates. Thus, the material, time and cost are reduced significantly. The laminate is flexible since it is made of polyurethane resin in the present invention. In addition, since no lubricant is used, the brightness lasts for long.

Other advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1a is a cross-sectional view of a laminate at a step of a method according to the present invention, and shows an auxiliary layer formed on releasing paper.

FIG. 1b is a cross-sectional view of the laminate at another step of the method according to the present invention, and shows a main layer formed on the auxiliary layer.

FIG. 1c is a cross-sectional view of the laminate at another step of the method according to the present invention, and shows the releasing paper removed in order to form a macromolecular laminate.

### DETAILED DESCRIPTION OF EMBODIMENTS

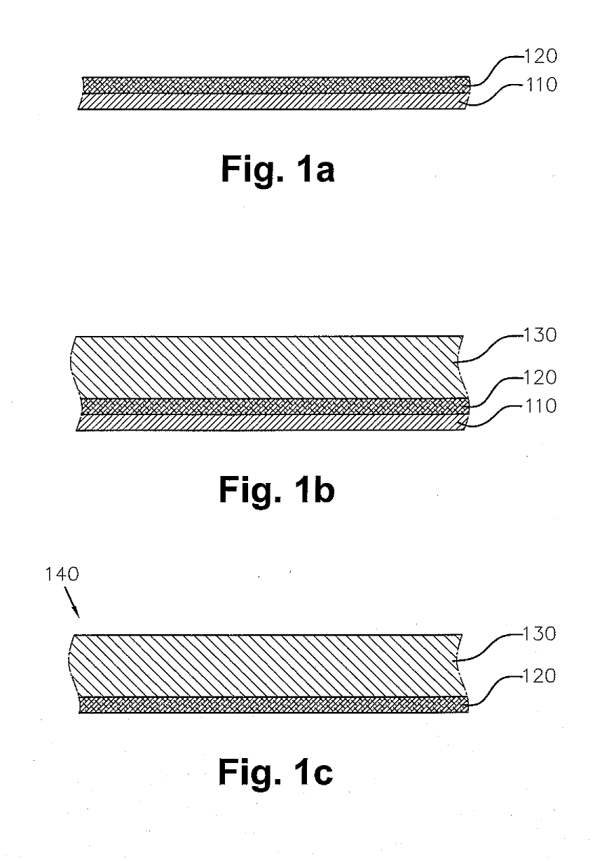

Referring to FIGS. 1a through 1c, a method for making a macromolecular laminate according to the present invention will be described. Firstly, referring to FIG. 1a, polyurethane resin is coated on releasing paper 110 and dried to form an auxiliary layer 120. Then, referring to FIG. 1b, high solid-content polyurethane resin is coated on the auxiliary layer 120 and dried and cured to form a main layer 130. Finally, referring to FIG. 1c, the releasing paper 110 is removed to form a macromolecular laminate 140 with thickness of 0.01 to 3 mm.

A feature of the present invention is using the liquid high solid-content polyurethane resin to form the rather thick main layer 130 (the thickness of the main layer 130 may reach 3 mm) in order to provide the thick and elastic laminate 140.

The solid content of the polyurethane resin for making the main layer 130 is higher than 50% by weight and, more preferably, 80% to 100% by weight and, most preferably, 99% by weight. More specifically, the high solid-content polyurethane resin contains a relative small amount of organic dissolvent and does not release a large amount of organic dissolvent when forming the main layer 130. The thickness of the high solid-content polyurethane resin only changes a little before and after it is dried so that the polyurethane resin can easily form the thick main layer 130 that is thick and flexible. Furthermore, for many purposes, one or more additives, such as filler, auxiliary, crosslinker and colorant may be added to the high solid-content polyurethane resin. Preferably, the filler should be less than 50% by weight of the high solid-content polyurethane resin. The auxiliary should be less than 20% by weight of the high solid-content polyurethane resin. The crosslinker should be less than 20% by weight of the high solid-content polyurethane resin. The colorant should be less than 15% by weight of the high solid-content polyurethane resin. In the embodiment of the present invention, preferably, the high solid-content polyurethane resin is baked at about 100 to 170 degrees Celsius. Moreover, foaming agent may be added to the high solid-content polyurethane resin in order to form a porous main layer 130.

Another feature of the present invention is using the low solid-content polyurethane resin to form the auxiliary layer 120 on the main layer 130. The solid content of the polyurethane resin for making the auxiliary layer 120 is lower than 50% by weight and, more preferably, 10% to 30% by weight. For being made of the low solid-content polyurethane resin, the auxiliary layer 120 is thinner than the main layer 130. The auxiliary layer 120 may exhibit a different color than the main layer 130 so that the laminate 140 exhibits a desired color. Based on design requirements, the auxiliary layer 120 may be made to include a plurality of layers with a same color or different colors. Furthermore, the releasing paper 110 may include patterns in order to leave patterns on the laminate 140 after it is removed.

The present invention is characterized in using the high solid-content polyurethane resin compound to form the thick macromolecular laminate 140. Because no solid macromolecular compound is used, there is no need to control complicated variables for solving problems related to the melting, rheology and temperature of such solid macromolecular compound. In addition, a blender and a coating device can be used instead of a conventional bulky and complicated machine. Thus, the laminate 140 can be made at a small or large number based on the need. Furthermore, only the blender and the coating device have to be cleaned between two different batches of laminates 140. Thus, the material, time and cost are reduced significantly. The laminate 140 is flexible since it is made of polyurethane resin in the present invention. In addition, because no lubricant is used, the brightness lasts for long. The macromolecular laminate of the present invention may be used as a logo or a surface layer adhered to ordinary leather.

The following embodiments are given to describe, not to limit the present invention in detail:

### Example 1

100 PHR of polyurethane resin with solid content of 99% by weight, 20 PHR of filler, 3 PHR of modifier, 5 PHR of crosslinker and 3 PHR of colorant were mixed to form high solid-content polyurethane resin coating. PHR (“parts per hundred parts of resin by mass”) means an amount of units of mass of additive added to 100 units of mass of the polyurethane resin.

After coated on patterned releasing paper, the polyurethane resin was dried at 165 degrees Celsius. Finally, the releasing paper was removed, thus leaving a thick, flexible and patterned laminate. The thickness of the laminate was 0.5 mm.

### Example 2

100 PHR of polyurethane resin with solid content of 99% by weight, 20 PHR of filler, 3 PHR of modifier, 5 PHR of crosslinker and 3 PHR of were mixed to form high solid-content polyurethane resin coating. PHR (“parts per hundred parts of resin by mass”) means an amount of units of mass of additive added to 100 units of mass of the polyurethane resin.

Low solid-content polyurethane resin compound made of polyurethane resin with solid content lower than 20% by weight was coated on releasing paper. The low solid-content polyurethane resin compound was dried at 120 degrees Celsius to form an auxiliary layer. The high solid-content polyurethane resin was coated on releasing paper and dried at 165 degrees Celsius. Then, the releasing paper was removed, thus leaving a brightly colorful, thick and flexible laminate. The thickness of the laminate was 0.5 mm.

### Comparative Example

Solid TPU resin was extruded to make a macromolecular laminate of a thickness of 0.5 mm.

The softness of the laminate of the comparative example was about 1.9, whereas the softness of the Example 1 and Example 2 was about 4.8. The softness test was conducted by a leather softness tester whose model number was BLC ST300 and manufactured by RWD BRAMLEY, a British company. The tested leather was softer, as the value was higher. Thus, the laminate made according to the present invention is much softer than the conventional laminate.

The present invention has been described via detailed illustration of some embodiments. Those skilled in the art can derive variations from the embodiments without departing from the scope of the present invention. Therefore, the embodiments shall not limit the scope of the present invention defined in the claims.

What is claimed is:

1. A macromolecular laminate comprising a main layer made of a first type of polyurethane resin compound that is liquid at room temperature, with the first type of polyurethane resin compound being made through mixing polyurethane resin with solid content higher than 50% by weight with at least one additive.

2. The macromolecular laminate according to claim 1, further comprising an auxiliary layer on the main layer, with the auxiliary layer being made of a second type of polyurethane resin compound different from the first type of polyurethane resin compound.

3. The macromolecular laminate according to claim 2, with the second type of polyurethane resin compound being made of polyurethane resin with solid content lower than 50% by weight.

4. The macromolecular laminate according to claim 2, with the auxiliary layer having a thickness smaller than that of the main layer.

5. The macromolecular laminate according to claim 4, with the thickness of the auxiliary layer being about 1%-49% of an overall thickness of the macromolecular laminate.

6. The macromolecular laminate according to claim 2, with said at least one additive including a colorant to provide the main layer with a color, and with the auxiliary layer having a different color than the main layer.

7. The macromolecular laminate according to claim 6, with the auxiliary layer being a laminate of a plurality of layers each having a color, and with the colors of the plurality of layers being different from one another.

8. The macromolecular laminate according to claim 1, with the macromolecular laminate having a thickness about 0.01-3 mm.
